(19) United States
(12) Patent Application Publication
(10) Pub. No.: US 2012/0150560 A1
(43) Pub. Date: Jun. 14, 2012

(54) METHODS AND APPARATUS TO DETECT AND UTILIZE CHANGES IN CONTEXT DATA FOR HEALTHCARE INFORMATION SYSTEMS

(75) Inventor: John R. Ferguson, Concord, MA (US)

(73) Assignee: General Electric Company, Schenectady, NY (US)

(21) Appl. No.: 12/967,997

(22) Filed: Dec. 14, 2010

(51) Int. Cl. G06Q 50/00; G06Q 10/00

(52) U.S. Cl. 705/3

(57) ABSTRACT

Methods and apparatus to detect and utilize changes in context data are disclosed. An example method includes detecting that a user of a healthcare information system is interacting with information associated with a first patient via a first application; accessing a context manager to obtain patient context data associated with the first patient, the patient context data including a plurality of status variables indicative of a plurality of aspects of a course of treatment provided to the first patient; determining whether the patient context data associated with the first patient has changed between a first time and a second time later than the first; and in response to detecting a change in the patient context data associated with the first patient, triggering an action to enable the user of the healthcare information system to interact with information associated with the course of treatment provided to the first patient.

### FIELD OF THE DISCLOSURE

The present disclosure relates generally to healthcare information systems and, more particularly, to methods and apparatus to detect and utilize changes in context data for healthcare information systems.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Further, medical personnel may enter new information, such as medical history, diagnostic, financial, or treatment information into a medical information system before and/or after a completed medical procedure, analysis, and/or appointment.

### SUMMARY

An example computer implemented method for use with a healthcare information system includes detecting that a user of a healthcare information system is interacting with information associated with a first patient via a first application; accessing a context manager to obtain patient context data associated with the first patient, the patient context data including a plurality of status variables indicative of a plurality of aspects of a course of treatment provided to the first patient; determining whether the patient context data associated with the first patient has changed between a first time and a second time later than the first; and in response to detecting a change in the patient context data associated with the first patient, triggering an action to enable the user of the healthcare information system to interact with information associated with the course of treatment provided to the first patient.

An example tangible machine readable medium has instructions stored thereon that, when executed, cause a machine to at least detect that a user of a healthcare information system is interacting with information associated with a first patient via a first application; access a context manager to obtain patient context data associated with the first patient, the patient context data including a plurality of status variables indicative of a plurality of aspects of a course of treatment provided to the first patient; determine whether the patient context data associated with the first patient has changed between a first time and a second time later than the first; and in response to detecting a change in the patient context data associated with the first patient, trigger an action to enable the user of the healthcare information system to interact with information associated with the course of treatment provided to the first patient.

An example apparatus for use with a healthcare information system includes a context object manager to manage a plurality of context data objects, wherein a user of the healthcare information system creates a first definition to define a first one of the context data objects to include a combination of status variables indicative of an aspect of the healthcare information system; definitions storage to store the first definitions; a retriever to obtain values for the status variables; a detector to determine whether the user is engaged with a device associated with the healthcare information system; a retriever is to retrieve values for the status variables in response to the detector determining that the user is engaged with the device; a comparator to determine whether the context data object has changed from a first instance of the context data object; and a toolset including a plurality of components capable of triggering one or more actions in response to the comparator determining that the context data object has changed from the first instance of the context data object.

### BRIEF DESCRIPTION OF THE DRAWINGS

FIG. 1 is a block diagram of an example healthcare information system.

FIG. 2 is a block diagram of an example apparatus that may be used to implement the example context module of FIG. 1.

FIG. 3 is a flow diagram representative of example machine readable instructions that may be executed to implement the example context module of FIGS. 1 and/or 2.

FIG. 4 is a flow diagram representative of example machine readable instructions that may be executed to implement the example prompt generator of FIG. 2.

FIG. 5 is a flow diagram representative of example machine readable instructions that may be executed to implement the example document access grantor of FIG. 2.

FIG. 6 is a flow diagram representative of example machine readable instructions that may be executed to implement the example application router of FIG. 2.

FIG. 7 is a block diagram of an example processor system that may be used to execute the machine readable instructions of FIGS. 3-6 to implement the example context module of FIGS. 1 and/or 2 and/or the components thereof.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Generally, the example methods, apparatus, systems, and/or articles of manufacture described herein detect and utilize changes in context data associated with healthcare information systems. The context data used by the examples described herein to generate the prompts may be, for example, CCOW (Clinical Context Object Workgroup) data and/or any other suitable context data corresponding to any suitable protocol. While the following description includes examples utilizing CCOW data, the example methods, apparatus, systems, and/or articles of manufacture described herein can utilize any other suitable type of context data (e.g., in combination with CCOW data and/or in isolation) to implement the functionality disclosed herein and the advantages provided thereby.

Typically, context data is maintained by healthcare information systems to enable synchronization across disparate applications or programs executed on a healthcare information device (e.g., a medical workstation at a hospital or clinic) being used by a healthcare practitioner (e.g., a physician, a physician's assistant, a nurse, a support staff member, administrative personnel, a member of a billing department, etc.). The CCOW standard, for example, uses a technique referred to as “context management” to provide a unified view of information associated with separate and/or different healthcare applications related to a subject (e.g., a patient, a user, a practitioner, and/or a healthcare event (e.g., an appointment, test, analysis, trauma, procedure, etc.), a location, etc.). In such instances, when a practitioner enters patient identifying data into a first application (e.g., an admissions program) of a CCOW-enabled system to cause a presentation of information related to the patient in the first application, a second application (e.g., a financial program) of the CCOW-enabled system automatically retrieves its respective information related to the patient and displays the same to the user of the system. Among other advantages, such a system aides the user in avoiding mistakes arising from the first application displaying information related to a first patient and the second application displaying information related to a second patient on the same screen. In such instances, the user may erroneously reference data related to the first patient in the first application while dealing with the second patient and, therefore, enter or provide the wrong information to a system or person. In other words, the unified view provided by a CCOW-enabled system ensures that a user interacting with multiple applications on a device is presented with the proper information across each of the applications or programs running on the device.

To implement context management, CCOW-enabled systems include and/or communicate with a central server called a context manager that is accessible by, for example, a healthcare workstation. The context manager and/or a storage device managed thereby stores context data related to each of a plurality of patients. The context data includes, for example, one or more variables indicative of statuses of various aspects of a course of treatment provided to a patient, such as patient identifier(s), financial status indicator(s), billing address(es), mailing address(es), insurance indicator(s), appointment(s), encounter(s), availability of test result(s), etc. Context data also includes, for example, one or more variables indicative of statuses of aspects of a healthcare information system or device, such as a user of the healthcare information device, a healthcare provider, a location (e.g., of the user, the provider, the healthcare information device, etc.), whether the user of the healthcare information device is currently in contact or communication (e.g., via telephone communication, over an Internet chat session via an instant messaging application, etc.), etc.

As described in greater detail below, context data can change in response to an event (e.g., a clinical encounter between a patient and a healthcare practitioner) or availability of new data (e.g., when lab results become available), for example. The example methods, apparatus, systems, and/or articles of manufacture described herein identify these changes in context data and utilize the identified changes to, for example, generate one or more prompts to be conveyed to a user related to an identified change in the context data, direct a user to an application or program needed to address an issue corresponding to an identified change in context data, generate metrics and/or reports analyzing identified changes in context data, provide a user with a capability to generate and store one or more notes related to an identified change in context data, to grant access to the user to protected documents related to the change in context data, and/or to provide additional or alternative services and advantages described in detail below. In some examples, the user is able to define which type(s) of context data the examples disclosed herein are to monitor for that particular user. In such instances, the user can also define combinations of different context data to be monitored by the examples disclosed herein. Further, the examples disclosed herein enable the user to define actions to be taken in response to detections of changes in context data. In other words, users of the examples disclosed herein are able to customize the context data to be monitored and/or the manner in which the context data is utilized. As a result, the user is better able to communicate information to the patient when, for example, one or more aspects (e.g., those corresponding to the changed contextual data) of the patient's healthcare situation has changed (e.g., as detected by the identified changes in context data).

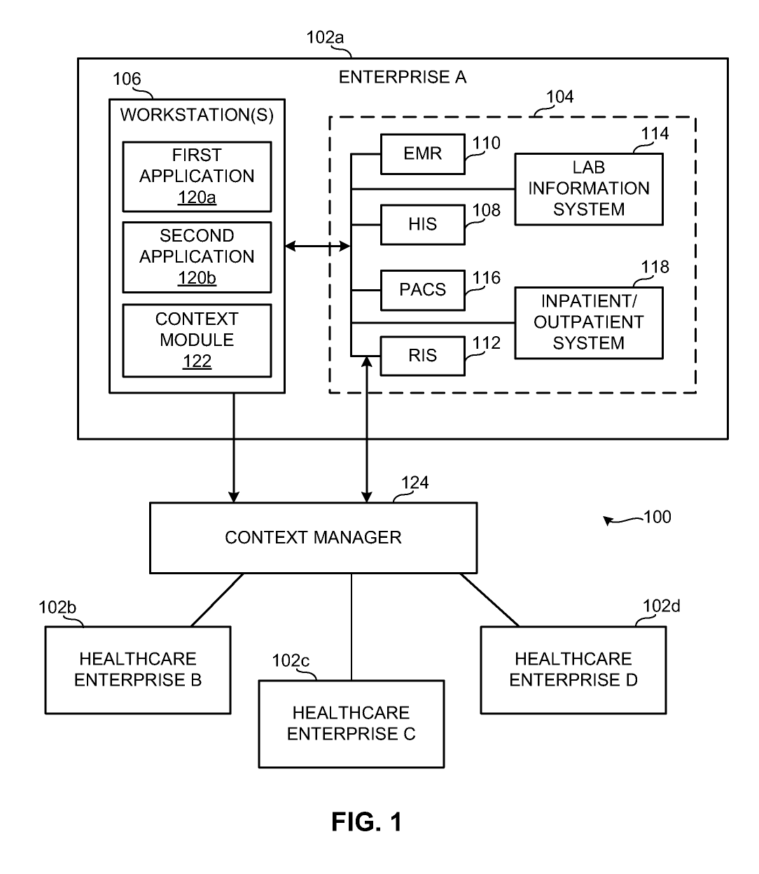

FIG. 1 is a block diagram of an example healthcare information system 100 in which the example methods, apparatus, systems, and/or articles of manufacture described herein may be implemented to detect and utilize changes in context data. The example healthcare information system 100 includes a plurality of healthcare enterprises 102a-d configured to share healthcare information. For example, the example healthcare information system 100 of FIG. 1 may implement an XDS (Cross Enterprise Document Sharing) integration profile to facilitate the sharing (e.g., registration, distribution, access, etc.) of healthcare data among the healthcare enterprises 102a-d (which are collectively referred to as an Affinity Domain in IHE XDS terminology). While the example healthcare data sharing system 100 of FIG. 1 is shown as including multiple healthcare enterprises, the example methods, apparatus, systems, and/or articles of manufacture described herein may be implemented in association with any additional or alternative type of healthcare information system, such as a standalone healthcare enterprise and/or an alternative type of information sharing system (e.g., a Regional Health Information Organization (RHIO) or Health Information Exchange (HIE)).

In the illustrated example of FIG. 1, the enterprise labeled with reference numeral 102a is illustrated and described herein as a hospital. However, any of the enterprises 102a-d may be any type of healthcare facility such as, for example, a clinic, a physician's office, a laboratory, a testing center, etc. Further, while FIG. 1 illustrates the components of the hospital 102a, the other enterprises (enterprises 102b-d) may include additional, alternative, and/or similar components, although not shown for purposes of brevity and not limitation.

The example hospital 102a includes a healthcare data system 104 and a plurality of workstations, one of which is shown in FIG. 1 labeled with reference numeral 106. The healthcare data system 104 includes a hospital information system (HIS) 108, an electronic medical record (EMR) system 110, a radiology information system (RIS) 112, a lab information system 114, a picture archiving and communication system (PACS) 116, and an inpatient/outpatient system 118. In the illustrated example, the HIS 108, the EMR system 1120, the RIS 112, the lab information system 114, the PACS 116, and the inpatient/outpatient system 118 are housed in the hospital 102a and locally archived. However, in other implementations, the HIS 108, the EMR system 1120, the RIS 112, the lab information system 114, the PACS 116, and/or the inpatient/outpatient system 118 may be housed one or more other suitable locations. Furthermore, one or more components of the healthcare data system 104 may be combined and/or implemented together. For example, the RIS 112 and/or the PACS 116 may be integrated with the HIS 108; the PACS 116 may be integrated with the RIS 112; and/or the six example information systems 110-118 may be integrated together. Preferably, information (e.g., test results, observations, diagnosis, discharges, admissions, etc.) is entered into the information system(s) 110-118 by healthcare practitioners (e.g., radiologists, physicians, technicians, administrators, etc.) before, after, and/or during a patient examination and/or testing session.

The HIS 108 stores healthcare information such as clinical reports, patient information, practitioner information, and/or financial data received from, for example, personnel at a hospital, clinic, and/or a physician's office. The EMR system 114 stores administrative information related to patients and/or practitioners, medical histories, current treatment records, etc. In some examples, the EMR system 113 stores information according to one or more departmental assignments and/or designations. The RIS 112 stores information such as, for example, radiology reports, messages, warnings, alerts, patient scheduling information, patient demographic data, patient tracking information, and/or physician and patient status monitors. Additionally, the RIS 112 enables exam order entry (e.g., ordering an x-ray of a patient) and image and film tracking (e.g., tracking identities of one or more people that have checked out a film).

The lab information system 114 stores clinical information such as lab results, test scheduling information, corresponding practitioner(s), and/or other information related to the operation(s) of one or more labs at the corresponding healthcare facility. The PACS 116 stores medical images (e.g., x-rays, scans, three-dimensional renderings, etc.) as, for example, digital images in a database or registry. Images are stored in the PACS 116 by healthcare practitioners (e.g., imaging technicians, physicians, radiologists) after a medical imaging of a patient and/or are automatically transmitted from medical imaging devices to the PACS 116 for storage. In some examples, the PACS 116 may also include a display device and/or viewing workstation to enable a healthcare practitioner to communicate with the PACS 116. The inpatient/outpatient system 118 stores information related to the admission and discharge of patients such as follow up schedules, patient instructions provided by a practitioner, prescription information, presenting symptoms, contact information, etc.

While example types of information are described above as being stored in certain elements of the healthcare data system 104, different types of healthcare data may be stored in one or more of the HIS 108, the EMR system 110, the RIS 112, the lab information system 114, the PACS 116, and/or the inpatient/outpatient system 118. Further, the information stored in these elements may overlap and/or share types of data.

The HIS 108, the EMR system 1120, the RIS 112, the lab information system 114, the PACS 116, and/or the inpatient/outpatient system 118 may be in communication via, for example, a Wide Area Network (WAN) such as a private network or the Internet. More generally, any of the coupling(s) described herein may be via a network. In such instances, the network may be implemented by, for example, the Internet, an intranet, a virtual private network, a wired or wireless Local Area Network, and/or a wired or wireless Wide Area Network. In some examples, the healthcare data system 104 also includes a broker (e.g., a Mitra Imaging's PACS Broker) to allow medical information and medical images to be transmitted together and stored together.

In some examples, information stored in one or more components of the healthcare data system 104 is formatted according to the HL-7 clinical communication protocol, the DICOM protocol, and/or any other suitable standard and/or protocol. The equipment used to obtain, generate, and/or store the information of the medical information system 106 may operate in accordance with the HL-7 clinical communication protocol, the DICOM protocol, and/or any other suitable standard and/or protocol. In some examples, the equipment used to obtain, generate, and/or store the information of the healthcare data system 104 may not operate in accordance with a standardized protocol. As described above, such differences in the modes of operation of medical equipment leads to complexities (e.g., the interface engine described above) encountered when attempting to share related healthcare documents in, for example, an HIE and/or an RHIO.

The workstation 106 may be any equipment (e.g., a personal computer) capable of executing software that permits electronic data (e.g., medical reports) and/or electronic medical images (e.g., x-rays, ultrasounds, MRI scans, medical reports, test results, etc.) to be acquired, stored, or transmitted for viewing and operation. The workstation 106 receives commands and/or other input from a user (e.g., a physician, surgeon, nurse, or any other healthcare practitioner) via, for example, a keyboard, mouse, track ball, microphone, etc. The example workstation 106 implements a user interface to enable a healthcare practitioner to interact with the healthcare data system 104 and the components thereof. In some examples, the user interface enables a search of one or more components or elements of the healthcare data system 104 and/or one or more external databases (e.g., a database storing financial information related to patient account) containing relevant healthcare information. A healthcare practitioner can use such a user interface to search medical resources using different criteria such as, for example, a patient name, a patient identification number, date(s) of treatment(s), type(s) of treatment, and/or any other suitable search criteria. In some examples, the healthcare practitioner logs on to the healthcare data system 104 before using the search interface and, thus, makes his or her identity known to the system 104. That is, the user interface is aware of which healthcare practitioner is using the system and, in some examples, creates an identification entry in a memory (e.g., a temporary memory entry) corresponding to the identified healthcare practitioner.

To interact with one or more components of the healthcare data system 104, the workstation 106 includes a plurality of programs or applications 120, two of which are shown in FIG. 1 as a first application 120a and a second application 120b. The application(s) 120 are programmed to, for example, retrieve information from a corresponding component of the healthcare data system 104, configure equipment associated with a corresponding component of the healthcare data system 104, present data associated with a corresponding component of the healthcare data system 104, and/or otherwise interact with one or more components of the healthcare data system 104. In the illustrated example of FIG. 1, the first application 120a is a patient history application capable of providing information to a user thereof regarding medical histories of, for example, patients under the care of a certain group of healthcare practitioners (e.g., physicians). In some examples, the patient history application 120a accesses the EMR system 110, the inpatient/outpatient system 118, and/or any other component of the healthcare data system 104. The example application(s) 120 may also include applications not directly related to the healthcare data system 104. For example, the second application 120b of the illustrated example of FIG. 1 is a financial application capable of providing information to a user thereof regarding patient accounts associated with, for example, patients under the care of a certain group of healthcare practitioners. The financial application 120b may access one or more external databases storing financial information related to, for example, patient accounts and billing information associated with the accounts.

The example workstation 106 of FIG. 1 also includes a context module 122. Generally, the example context module 122 identifies changes in context data and utilizes the identified changes to improve an ability of a user of the workstation 106 to, for example, interact with the healthcare data system 104 and to communicate with patients. To detect the changes in context data, the example context module 122 of FIG. 1 communicates with a context manager 124. The example context manager 124 of FIG. 1 is implemented by a CCOW context manager. However, some examples may include additional or alternative types of context manager(s). As described above, the context manager 124 executes context management operations that include storing and maintaining a plurality of context data variables indicative of statuses associated with, for example, patients, users of the workstation 106, and/or the workstation 106 itself. While the example system 100 of FIG. 1 utilizes a CCOW context manager, the example context module 122 may use any other suitable type of context management device and/or system to provide the functionality described herein.

The context manager 124 is also in communication with the other healthcare enterprises 102b-d, which may also include one or more workstations similar to the example workstation 106 of the hospital 102a implementing an instance of the example context module 122. In some examples, the context module 122 may be implemented in a centralized device such as, for example, a central server accessible by the workstation 106 over a network, the context manager, or a server implemented in the hospital 102a. In such instances, the workstation 106 of the hospital 102a acts as a client device that utilizes the functionality of the context module implemented on the centralized device in a client-server configuration.

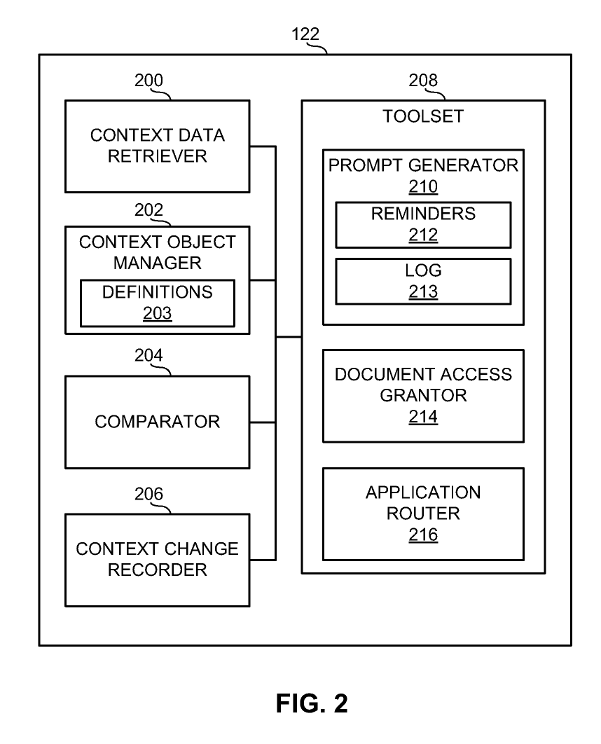

FIG. 2 is a block diagram of an example apparatus that may be used to implement the example context module 122 of FIG. 1. In the illustrated example of FIG. 2, the example print driver 120 includes a context data retriever 200, a context object manager 202, a comparator 204, a context change recorder 206, a prompt generator 210, a document access grantor 214, and an application router 216. While an example manner of implementing the context module 122 of FIG. 1 has been illustrated in FIG. 2, one or more of the elements, processes and/or devices illustrated in FIG. 2 may be combined, divided, re-arranged, omitted, eliminated and/or implemented in any other way. Further, the example context data retriever 200, the example context object manager 202, the example comparator 204, the example context change recorder 206, the example prompt generator 210, the example document access grantor 214, the example application router 216, and/or, more generally, the example context module 122 of FIG. 2 may be implemented by hardware, software, firmware and/or any combination of hardware, software and/or firmware. Thus, for example, any of the example context data retriever 200, the example context object manager 202, the example comparator 204, the example context change recorder 206, the example prompt generator 210, the example document access grantor 214, the example application router 216, and/or, more generally, the example context module 122 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example context data retriever 200, the example context object manager 202, the example comparator 204, the example context change recorder 206, the example prompt generator 210, the example document access grantor 214, the example application router 216, and/or, more generally, the example context module 122 of FIG. 2 are hereby expressly defined to include a tangible medium such as a memory, DVD, CD, etc., storing the software and/or firmware. Further still, the example context module 122 of FIG. 2 may include one or more elements, processes and/or devices in addition to, or instead of, those illustrated in FIG. 2, and/or may include more than one of any or all of the illustrated elements, processes and devices.

The example context data retriever 200 obtains context data from the context manager 124 of FIG. 1. In the illustrated example of FIG. 2, the context data retriever 200 retrieves context data from the context manager 124 in response, for example, to a user of the workstation 106 entering patient-identifying information into one of the applications 120, according to a schedule (e.g., daily at a time during which network traffic is low, such as early morning hours), and/or in response to an instruction from a user of the workstation 106 and/or an administrator of the system 100 or the context module 122. The example context data retriever 200 may retrieve targeted instances of context data (e.g., selected from a list of available types of context data) associated with targeted patients (e.g., using patient identifiers provided by the user of the workstation 106) and/or may retrieve context data in bulk fashion without specific data targets or patient targets. Further, the example context data retriever 200 of FIG. 2 retrieves context data related to the user and/or the workstation 106 in response to the user logging onto the workstation 106 and/or repeatedly during a session of the user on the workstation 106.

The example context object manager 202 creates objects including a plurality of fields corresponding to a plurality of types of context data. In the illustrated example, the object manager 202 creates one or more objects according to a set of default definitions 203 and/or definition(s) 203 configured by user(s) of the workstation 106 and/or the context module 122. The definitions determine the type of context data to be utilized by the context module 122 (e.g., in one or more manners described below in connection with the toolset 208). In addition to creating the objects, the example object manager 202 of FIG. 2 assigns values to the fields of the objects according to the information obtained by the example content data retriever 200.

Thus, in examples context objects focused on patient data, the example context object manager 202 of FIG. 2 maintains a set of context data values for fields maintained in the context manager 124 including, for example, a patient identifier field (e.g., CurrentPatient), a group identifier field (e.g., PatientGroup), an insurance field (e.g., PatientInsurance), an appointment field (e.g., PatientAppointment), a patient employment field (e.g., PatientEmployment), an account field (e.g., CurrentAccount), a communication status field (e.g., OnPhone), a notes field (e.g., Notes) and a role field (e.g., PatientIsAClinician). Additionally, the context object manager 202 can maintain a set of context values for fields related to a user session of the workstation 106 including a user identifier field (e.g., UserRole), a user interface field (e.g., CurrentMenuItem), and/or a workstation status field (e.g., AutoDialerInUse). These fields receive values associated with operation of the workstation 106 and the user thereof while the user is dealing with a patient. Thus, these fields may change with the context of an encounter. For example, a field of the object may identify what type of user using the workstation 106 is currently working with the object corresponding to a patient. In some examples, the user can set the definitions 203 to combine two or more context fields to cause the context object manager 202 to create and maintain a customized context object to be monitored. For examples, the user (and/or a system device or system administrator) can combine the patient identifier field (e.g., CurrentPatient) with the communication status field (e.g., OnPhone) in the definitions 203 to define a context data object to be monitored by the context module 122. Accordingly, each object managed by the context object manager 202 reflects a status of a plurality of aspects of healthcare associated with a corresponding patient and/or a user session with the workstation 106.

To detect changes in the context data of the context objects, the example context module 122 includes the comparator 204. The example comparator 204 compares a first field value of a context object corresponding to a first time to a second field value of the context object corresponding to a second time later than the first time. The first time may be prior to an inquiry into a corresponding patient at the workstation 106 while the second may be after the context data retriever 200 obtains current context data from the context manager 124 in response to the fore mentioned inquiry and the object manager 202 has updated the field values of the context object. When the first field value of the context object is different from the second field value, the example context module 122 has detected a change in context data associated with a corresponding patient.

The detection of the change in context and information associated therewith (e.g., the field of the object that underwent a change) is conveyed to the example context change recorder 206. The example context change recorder 206 of FIG. 2 records the detected change in context in association with any suitable additional information such as, for example, a timestamp, an identifier of the corresponding user of the workstation at the time of the detected change, etc. Additionally, the example context change recorder 206 can generate one or more metrics and/or reports analyzing the information recorded therein. The metrics and/or reports can be conveyed to, for example, a requesting healthcare practitioner and/or an administrator of the context module 122, the hospital 102a, and/or the healthcare data system 104.

The change in context data detected by the comparator 204 is also conveyed to one or more components of the example toolset 208 of FIG. 2. As described below, the components of the toolset 208 utilize the detected change in context data to improve workflows of healthcare practitioners using the workstation 106, accuracy of data entrance into the healthcare data system 104, communication with the patient regarding various aspects of his or her treatment, access to relevant materials, identification and resolution of problems or issues with the records associated with a patient, and/or additional aspects of the healthcare information system 100. In the illustrated example, the toolset components that receive the context change indication and the information associated therewith depends on the type of context data (e.g., which of the fields of the object) that has changed. However, in some examples, the context change indication and the information associated therewith may be sent to each of the toolset components and/or a subset thereof. Further, different components of the toolset 208 may require different levels of authorization for the user of the workstation 106 to utilize the different components. For example, a first component of the toolset 208 (e.g., the prompt generator 210) may interact with the user of the workstation 106 (e.g. by providing information to the user and/or granting particular accesses to the user) regardless of a clearance level associated with the user, while a second component of the toolset 208 (e.g., the application router 216) may restrict the user of the workstation 106 from interacting therewith out proper authorization. The proper authorization can be obtained, for example, from a username and password entered into the workstation 106 at an onset of a session associated with the user. This authorization configuration prohibits certain users (e.g., a billing agent) from obtaining access to private information (e.g., medical test results or records) to which the user is not privileged.

In the illustrated example, for each detected change in context data, an indication of the change and data associated with the change are conveyed (e.g., by the example comparator 204) to the example prompt generator 210. The example prompt generator 210 of FIG. 2 analyzes the detected change indication and the associated information to determine whether a user of the workstation 106 is to be prompted with, for example, the information associated with the detected change. For example, the prompt generator 210 of FIG. 2 includes a list of the types of context data that, in the event of a change therein, causes a prompt to be generated. When receiving a context change indication, the example prompt generator 210 of FIG. 2 references the data associated with the change to identify which field of the corresponding object has changed. If the changed field of the context object corresponds to a type of context data in the list maintained by the prompt generator 210, the example prompt generator 210 causes a prompt to be displayed to a user of the workstation 106. As a result, a user of the workstation 106 can be informed of an aspect of a patient's healthcare that warrants attention regardless of which application the user is executing on the workstation. That is, even though a user is working with the financial application 120b of the workstation 106 of FIG. 1, the user is informed of important changes in non-financial aspects of the healthcare being provided to the corresponding patient, such as an aspect associated with the patient history application 120a (even though the patient history application 120a may not be executing at the time).

For example, if a field of the context object corresponding to a patient related to availability of test results has changed to indicate that new test results are now available, the example prompt generator 210 generates a prompt to the user of the workstation 106 regarding the availability of the test results. Because the example prompt generator 210 and, more generally, the example context module 122 use context information from the example context manager 124, such a prompt regarding test results can be generated and presented to the user of the workstation 106 regardless of whether the user of the workstation 106 is working with an application dedicated to test results. That is, the user of the workstation 106 is presented with important information regarding the availability of new test results no matter what type of application is being implemented on the workstation 106. As a result, the user is better informed of the entire context of the treatment being received by the patient. The user of the workstation 106 can take any suitable steps in response to the new availability such as, for example, contact the patient associated with the test results, contact a physician associated with the test results, enter the test results into a patient history, etc.

In another example, if a field of the context object corresponding to the patient related to an availability of an open slot in a clinical trial, the example prompt generator 210 generates a prompt to the user of the workstation 106 regarding the availability of the open slot. Again, because the example prompt generator 210 and, more generally, the example context module 122 use context information from the example context manager 124, such a prompt regarding the open slot can be generated and presented to the user of the workstation 106 regardless of whether the user of the workstation 106 is working with an application dedicated to clinical trial availability. As a result, as soon as the user is dealing with the patient (e.g., by entering an identifier associated with the patient into an application of the workstation 106) in any context, the user is informed of important changes to any context of the patient's healthcare, such as the newly available open slot of the clinical trail. In many instances, such a prompt enables the user of the workstation 106 to be informed of the open slot earlier than otherwise and, thus, increase the likelihood that the patient can be the first person to apply for the open slot. The user of the workstation 106 can take any suitable steps in response to the news of the open slot such as, for example, contact the patient, contact the physician, and/or automatically submit an application for the patient to an organization associated with the clinical trial having the open slot.

In another example, if a field of the context object corresponding to the patient related to notes associated with the patient, the example prompt generator 210 generates a prompt to the user of the workstation 106 regarding the presence of new notes associated with the patient. In the illustrated example, the user of the workstation 106 can access and/or alter the notes associated with the patient regardless of the context or application current executing on the workstation 106. That is, the user can create or modify a notes field associated with the context object and those notes or modifications are available across different contexts or operations of the workstation 106.

The example prompt generator 210 of FIG. 2 also includes a plurality of standard messages to be conveyed via the prompts in addition to the received data associated with the detected change or as a standalone message. For example, when the detected change corresponds to an insurance field of the context object, the resulting prompt may include a message instructing the user of the workstation 106 to send a recommendation to the corresponding patient to consult with an insurance counselor and/or the insurance provider of the patient. Such a message may be conveyed regardless of the substance of the detected change or may depend on the substance of the change. To continue the insurance example, the prompt generator 210 may only include the recommendation message when the change in the insurance policy of the patient caused a higher deductible or a loss of certain aspects of coverage. The example prompt generator 210 can be customized to generate any desired messages and/or prompts in response to any desired conditions or dependencies.

In another example, the change in context data occurs in a field of the context object dedicated to a communication status between the user of the workstation 106 and the patient associated with the changed context object. In the illustrated example, the context object manager 202 creates and maintains a PatientOnPhone field in the context objects. When the detected change corresponds to the PatientOnPhone field being altered to indicate that the patient is on the phone with the user of the workstation 106, the example prompt generator 210 of FIG. 2 references a list of reminders 212 stored in association with the patient. If there is content in the reminders 212, the example prompt generator 210 conveys those reminders to the user of the workstation 106 with instructions to convey the reminders 212 to the patient while the patient is in direct communication with the user (e.g., over the phone). Thus, the user of the workstation 106 can remind the patient of, for example, upcoming appointments, an overdue balance in an account, prescriptions to be taken or other physician's orders to be followed, a need for the patient to schedule a certain test or procedure, etc. Notably, the example prompt generator 210 enables the user of the workstation 106 to be informed of the reminders 212 that span across multiple contexts (e.g., finances, scheduling, medications, etc.) regardless of the context or application currently displayed on the workstation 106. That is, like the other components of the toolset 208, the example prompt generator 210 provides important information to the user of the workstation 106 regardless of whether the user accessed an application related to the important information.

In some examples, the prompt generator 210 references a log 213 that records conveyances of the reminders 212 before conveying a reminder to a patient or recommending the same to the user. In such instances, the user is not prompted to send the reminder if that particular reminder was previously sent to the patient within a threshold amount of time (e.g., a day or a week).

When the detected change in context data occurs in a field of a context object related to the availability of medical documents, the indication of the change in context data and the information associated therewith is conveyed to the example document access grantor 214. As described above, the example prompt generator 210 may inform the user of the workstation 106 of an availability of new documents. In addition to such a prompt, the example document access grantor 214 may, in response to the change in context data related to the new documentation, automatically grant access to the user of the workstation 106 to the newly available documents. For example, when an analysis of a scan from a magnetic resonance imaging (MRI) procedure is stored in the PACS 116, a field of a context object related to newly available documentation is changed. This change is detected by the comparator 204 and conveyed to the example document access grantor 214. In response, the example document access grantor 204 authorizes the user of the workstation 106 to access the analysis and the underlying MRI images. The user may take any suitable steps with the images such as, for example, forwarding the images and the analysis to a physician related to the subject patient, contact the patient to inform the patient of the availability of the images, etc.

The example application router 216 receives indications of context data changes and identifies which, if any, of the applications 120 implemented on the workstation 106 corresponds to the context data change. Thus, if a detect change in context data relates to a patient financial account, the example application router 216 identifies the second application 120b of FIG. 1 as the application that relates to the substance of the change in context data. With this identification of one of the applications 120, the example application router 216 of FIG. 2 routes the user to the identified application in response to the context data change. For example, when the identified application is not running on the workstation 106, the example application router 216 opens an instance of the identified application and displays the same to the user on the workstation 106. When the identified application is running on the workstation 106, the example application router 216 causes a display associated with the identified application to be brought to the attention of the user by, for example, flashing an icon associated with the identified application with a different color, bringing the display associated with the identified application to the forefront of a screen (i.e., in front of other windows), etc. In either case (i.e., whether the identified application is running or not), the example application router 216 places the identified application in a context corresponding to the corresponding patient. That is, when the identified application is launched in response to the change in context data, the application router 216 opens the identified application and brings up the appropriate information corresponding to the patient associated with the detected change in context data. Further, when the identified application is highlighted or brought to the forefront of a display, the application router 216 changes (if necessary) the context of the application such that the appropriate information corresponding to the patient associated with the detected change in context data is displayed to the user of the workstation 106.

In some examples, the routing of the identified application to the user is performed in tandem with one of the prompts described above in connection with the example prompt generator 210. Thus, the user is made aware, via the prompt generator 210, of the change in context data and that certain actions need to be taken in response thereto, and is automatically routed to an application by which the certain actions can be performed. In some examples, the prompt displayed to the user of the workstation 106 includes an option for the user to launch the application deemed to be associated with the change in context data. For example, when the generated prompt is related to financial information, the prompt may include an option, selectable by the user, to launch a financial application (e.g., the second application 120b of FIG. 1).

Thus, generally, the example components illustrated in the example context module 122 of FIG. 2, utilize detected changes in context data to improve a workflow of a user of the workstation 106. The user is better aware of information relating to any relevant aspect of healthcare being provided to a patient despite, perhaps, not being engaged in that specific aspect of healthcare at a particular time. Such timely notification of information enables the user to better address potential issues quickly, better communicate with the patient, avoid potential oversights or errors, etc. The example toolset 208 may include additional or alternatively components that utilize the detected changes in context data in additional or alternative manners.

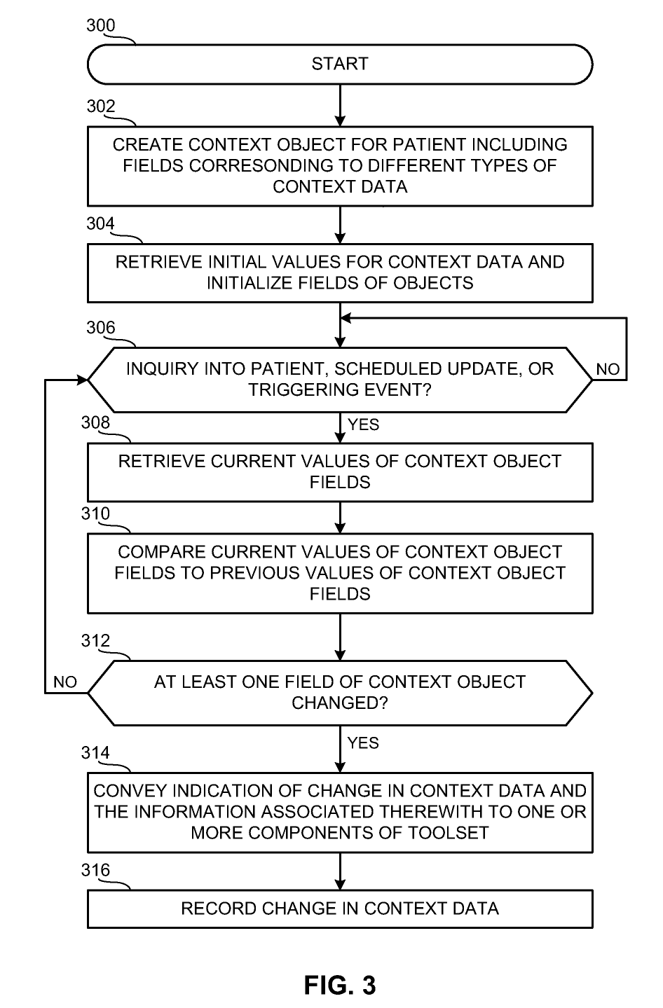

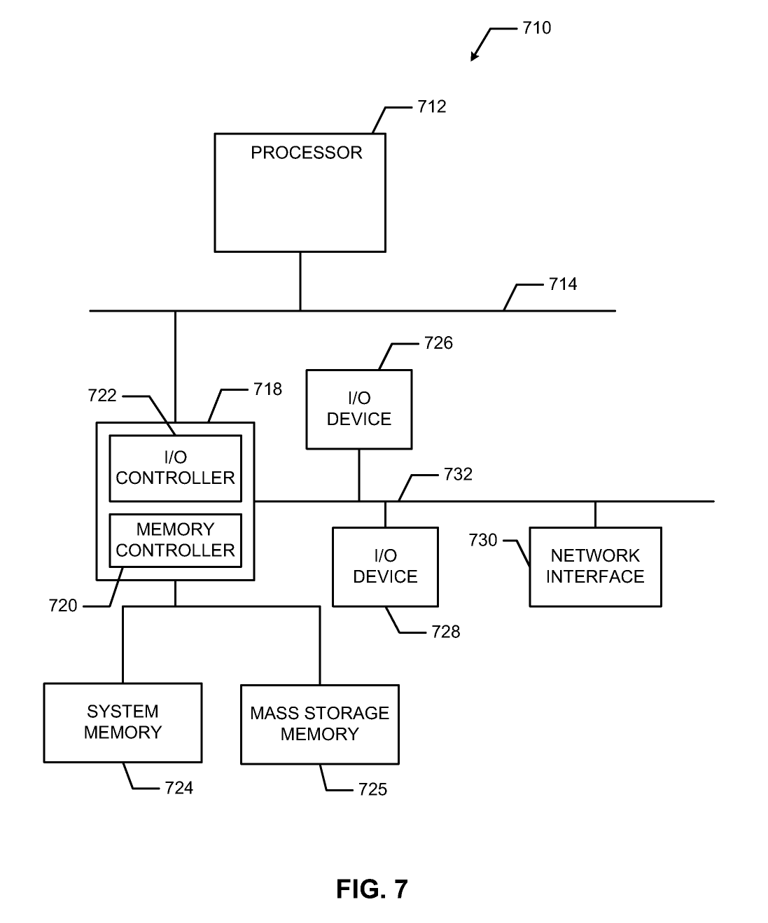

Turning to FIGS. 3-6, the flow diagrams depicted in FIGS. 3-6 are representative of machine readable instructions that can be executed to implement the example context module 122 of FIGS. 1 and/or 2 to detect and utilize changes in context information in healthcare information systems. The example processes of FIGS. 3-6 may be performed using a processor, a controller and/or any other suitable processing device. For example, the example processes of FIGS. 3-6 may be implemented in coded instructions stored on a tangible medium such as a flash memory, a read-only memory (ROM) and/or random-access memory (RAM) associated with a processor (e.g., the example processor 712 discussed below in connection with FIG. 7). Alternatively, some or all of the example processes of FIG. 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 3-6 may be implemented manually or as any combination(s) of any of the foregoing techniques, for example, any combination of firmware, software, discrete logic and/or hardware. Further, although the example processes of FIG. 3 are described with reference to the flow diagram of FIGS. 3-6, other methods of implementing the processes of FIGS. 3-6 may be employed. For example, the order of execution of the blocks may be changed, and/or some of the blocks described may be changed, eliminated, sub-divided, or combined. Additionally, any or all of the example processes of FIGS. 3-6 may be performed sequentially and/or in parallel by, for example, separate processing threads, processors, devices, discrete logic, circuits, etc.

The example flow diagram of FIG. 3 begins with an activation of the example context module 122 of FIGS. 1 and/or 2 (block 300). The example context object manager 202 (FIG. 2) creates at least one object for each patient associated with the context module 122 (block 302). Each object includes a plurality of fields corresponding to a plurality of types of context data. Which fields to be included in the objects by the example context module 122 can be determined by one or more settings that are customizable and recorded in the definitions 203. Therefore, the types of context data to be tracked by the example context module 122 can be dictated by one or more users or administrators of the healthcare information system 100 of FIG. 1.

The example context data retriever 200 then initializes the context objects by obtaining values from the context manager 124 of FIG. 1 and assigning the same to the appropriate fields of the context objects (block 304). As described above, the CCOW manager 124 of FIG. 1 maintains database(s) of context data associated with patients and the healthcare provided thereto. Thus, this initialization causes the context objects to reflect a status of the healthcare provided to each patient at a time corresponding to the activation of the context module 122. Additionally or alternatively, the context objects reflect status(es) of aspects of a user session on the workstation 106 (e.g., aspects associated with the user and/or aspects associated with the workstation 106 (e.g., whether the workstation 106 or a devices associated therewith, such as a telephone or an instant messaging application, is in communication with the patient)).

The initialized system then responds to an inquiry into a patient (e.g., a user of the workstation 106 entering patient-identifying information into one of the applications 120), a scheduled update (e.g., daily at a time during which network traffic is low, such as early morning hours), or any other triggering event defined by, for example, a set of customizable rules on a continuing basis. As illustrated in FIG. 3, when an inquiry into a patient, a scheduled update, or any other triggering event occurs (block 306), the example context data retriever 200 retrieves context data from the context manager 124 (block 308). As described above, the example context data retriever 200 may retrieve targeted instances of context data (e.g., selected from a list of available types of context data) associated with targeted patients (e.g., using patient identifiers provided by the user of the workstation 106) and/or may retrieve context data in bulk fashion without specific data targets or patient targets.

The example comparator 204 then compares the retrieved current context data values to the previous values of the context object (block 310). In the first iteration, the comparator 204 compares the retrieved values of the fields of the context objects to the initialized values set at block 304. When at least one field value of the context object retrieved at block 308 is different from a previous value of the corresponding field of the context object (block 312), the example context module 122 has detected a change in context data associated with a corresponding patient. Accordingly, in such instances, the comparator 204 conveys an indication of the change in context data and the information associated therewith (e.g., a new value of the changed field in the context object and the old value of the changed field in the context object) to one or more of the components of the toolset 208 (block 314). Also, the detection of the change in context and information associated therewith (e.g., the field of the object that underwent a change) is conveyed to the example context change recorder 206, which records the received information (block 316).

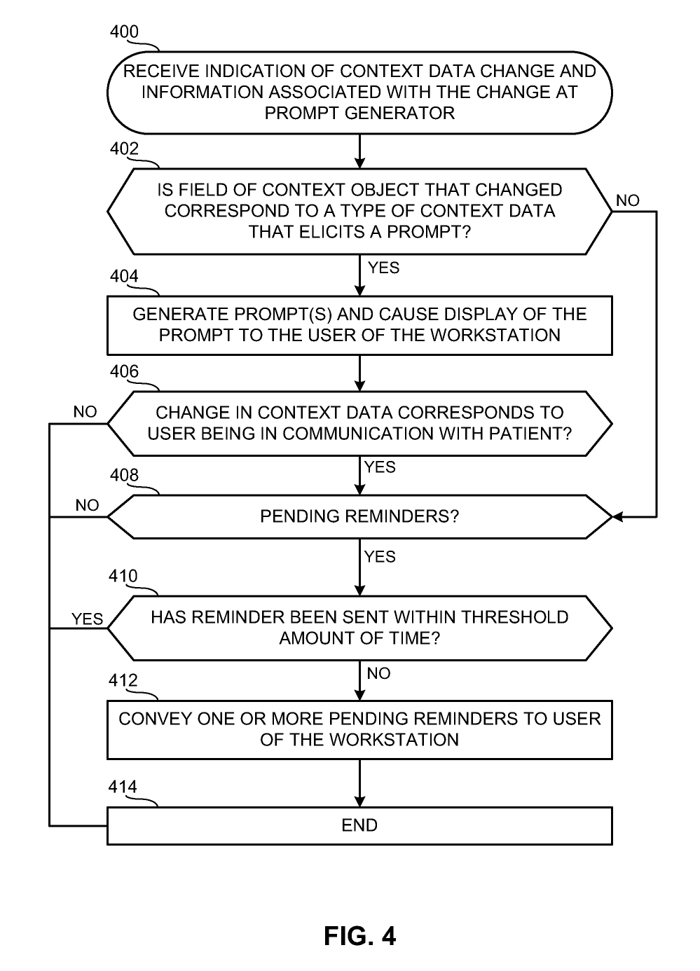

Turning to FIG. 4, the illustrated example begins with the prompt generator 210 of FIG. 2 receiving an indication of a change in context data and information associated with the change (block 400). For example, the prompt generator 210 may receive the indication and the information conveyed to the toolset 208 from the comparator 204 at block 314 of FIG. 3. The example prompt generator 210 references the list of types of context data that, in the event of a change therein, causes a prompt to be generated. The list includes entries that correspond to the fields of the context objects managed by the context object manager 202. When the field of the context object that changed corresponds to a type of context data that elicits a prompt according to the list maintaining by the prompt generator (block 402), the example prompt generator 210 generates one or more prompts and causes a display of the prompt and/or the information associated with the change (block 404). Subsequently, or when the field of the context object that changed does not correspond to a type of context data that elicits a prompt (block 402), the prompt generator determines whether the change in context data corresponds to a user of the workstation 106 currently being in communication with the corresponding patient (block 406). If so, the example prompt generator 210 references the reminders 212 to determine whether patient should be reminded of, for example, upcoming appointments, a need to schedule a procedure or appointment, prescriptions to pick up, etc. When such reminders are pending in the reminders 212 (block 408), the example prompt generator 210 checks the log 213 to determine whether a reminder has been conveyed to the corresponding patient within a threshold amount of time (block 410). If not, the example prompt generator 210 conveys instructions to the user of the workstation 106 to communicate the pending reminders to the patient (e.g., over the phone when the change in context data indicates that the user of the workstation 106 is currently on the phone with the patient, via email, etc.) (block 412). Otherwise, the example flow diagram of FIG. 4 ends (block 414).

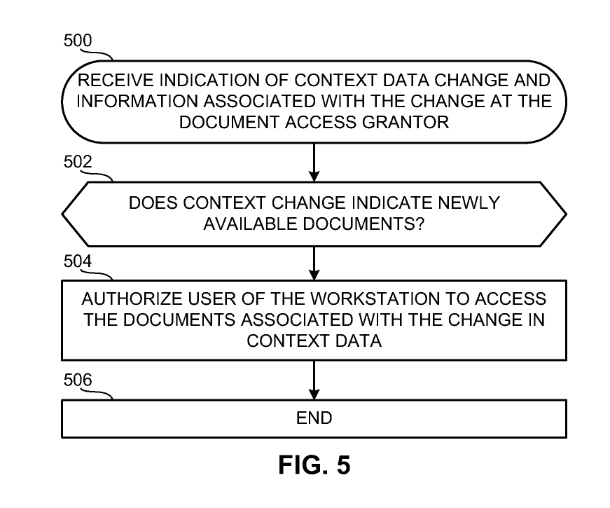

Turning to FIG. 5, the illustrated example begins with the document access grantor 214 of FIG. 2 receiving an indication of a change in context data and information associated with the change (block 500). For example, the document access grantor 214 may receive the indication and the information conveyed to the toolset 208 from the comparator 204 at block 314 of FIG. 3. The example document access grantor 214 determines whether the detected change in context data occurred in a field of a context object related to the availability of medical documents (block 502). If so, the example document access grantor 214 automatically grants access to the user of the workstation 106 (who is identifiable to the document access grantor via a username and password used to log onto the workstation 106 and a corresponding identifier) to the newly available documents (e.g., a scan from a magnetic resonance imaging (MRI) procedure (block 504). The example flow diagram of FIG. 5 then ends (block 506).

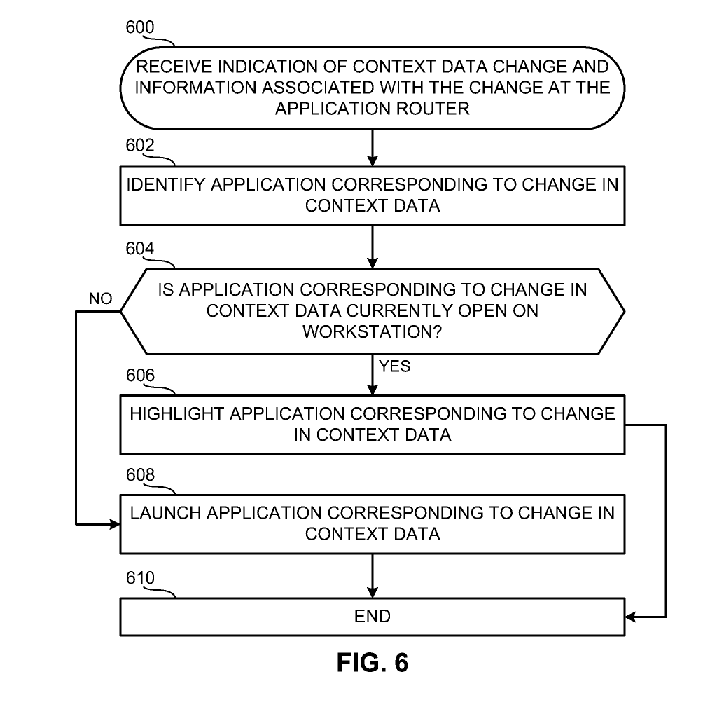

Turning to FIG. 6, the illustrated example begins with the application router 216 of FIG. 2 receiving an indication of a change in context data and information associated with the change (block 600). For example, the application router 216 may receive the indication and the information conveyed to the toolset 208 from the comparator 204 at block 314 of FIG. 3. The example application router 216 identifies which, if any, of the applications 120 implemented on the workstation 106 corresponds to the context data change (block 602). The example application router 216 then determines whether the identified application(s) are currently open or executing on the workstation 106 (block 604). If so, in the illustrated example, the application router 216 highlights the identified application(s) in an attempt to direct the attention of the user of the workstation 106 to the identified application(s) (block 606). The application router 216 may attempt to direct the attention of the user in additional or alternative manners, such as by bringing window(s) of the identified application(s) to the forefront of a screen display. If the identified application(s) are not currently open or executing on the workstation 106, the example application router 216 launches the identified application(s) (block 608). In addition to launching the identified application(s), the example application router 216 may also highlight or otherwise attempt to direct the attention of the user once the identified application(s) have been launched. The example flow diagram of FIG. 6 then ends (block 610).

FIG. 7 is a block diagram of an example processor system 710 that may be used to implement the apparatus and methods described herein. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for use with a healthcare information system, comprising:
detecting that a user of a healthcare information system is interacting with information associated with a first patient via a first application;
accessing a context manager to obtain patient context data associated with the first patient, the patient context data including a plurality of status variables indicative of a plurality of aspects of a course of treatment provided to the first patient;
determining whether the patient context data associated with the first patient has changed between a first time and a second time later than the first; and
in response to detecting a change in the patient context data associated with the first patient, triggering an action to enable the user of the healthcare information system to interact with information associated with the course of treatment provided to the first patient.

2. A computer implemented method as defined in claim 1, wherein triggering the action comprises generating a prompt to be displayed to the user of the healthcare information system, the prompt including information related to the change in the patient context data.

3. A computer implemented method as defined in claim 1, wherein triggering the action comprises launching a second application on the healthcare information system, the second application configured to provide services associated with a type of information associated with the changed patient context data.

4. A computer implemented method as defined in claim 1, wherein triggering the action comprises granting the user access to a document that is newly available according to the change in the patient context data.

5. A computer implemented method as defined in claim 4, further comprising authenticating the user of the healthcare information system before granting the user access to the document when the document includes privileged information.

6. A computer implemented method as defined in claim 1, further comprising instructing the user to convey the data related to the change in the patient context data to the first patient when the change in the patient context data warrants attention of the first patient.

7. A computer implemented method as defined in claim 1, wherein the change in the patient context data associated with the first patient comprises an alteration in an insurance plan associated with the first patient, and wherein triggering the action comprises generating a prompt including an alert for the first patient to consult with an insurance counselor.

8. A computer implemented method as defined in claim 1, wherein detecting that the user of a healthcare information system is interacting with information associated with the first patient comprises determining that the user is on a telephone conversation with the first patient, and wherein the change in patient context data associated with the first patient comprises the user of the healthcare information system being in contact with the first patient.

9. A tangible machine readable medium having instructions stored thereon that, when executed, cause a machine to at least:
detect that a user of a healthcare information system is interacting with information associated with a first patient via a first application;
access a context manager to obtain patient context data associated with the first patient, the patient context data including a plurality of status variables indicative of a plurality of aspects of a course of treatment provided to the first patient;
determine whether the patient context data associated with the first patient has changed between a first time and a second time later than the first; and
in response to detecting a change in the patient context data associated with the first patient, trigger an action to enable the user of the healthcare information system to interact with information associated with the course of treatment provided to the first patient.

10. A tangible machine readable medium as defined in claim 9, wherein triggering the action comprises generating a prompt to be displayed to the user of the healthcare information system, the prompt including data related to the change in the patient context data.

11. A tangible machine readable medium as defined in claim 9, wherein triggering the action comprises launching a second application on the healthcare information system, the second application configured to provide services associated with a type of information associated with the changed patient context data.

12. A tangible machine readable medium as defined in claim 9, wherein triggering the action comprises granting the user access to a document that is newly available according to the change in the patient context data.

13. A tangible machine readable medium as defined in claim 12 having instructions stored thereon that, when executed, cause a machine to authenticate the user of the healthcare information system before granting the user access to the document when the document includes privileged information.

14. A tangible machine readable medium as defined in claim 9 having instructions stored thereon that, when executed, cause a machine to instruct the user to convey the data related to the change in the patient context data to the first patient when the change in the patient context data warrants attention of the first patient.

15. A tangible machine readable medium as defined in claim 9, wherein the change in the patient context data associated with the first patient comprises an alteration in an insurance plan associated with the first patient, and wherein triggering the action comprises generating a prompt including an alert for the first patient to consult with an insurance counselor.

16. A tangible machine readable medium as defined in claim 9, wherein detecting that the user of a healthcare information system is interacting with information associated with the first patient comprises determining that the user is on a telephone conversation with the first patient, and wherein the change in the patient context data associated with the first patient comprises the user of the healthcare information system being in contact with the first patient.

17. An apparatus for use with a healthcare information system, comprising:
a context object manager to manage a plurality of context data objects, wherein a user of the healthcare information system creates a first definition to define a first one of the context data objects to include a combination of status variables indicative of an aspect of the healthcare information system;
definitions storage to store the first definitions;
a retriever to obtain values for the status variables;
a detector to determine whether the user is engaged with a device associated with the healthcare information system;
a retriever is to retrieve values for the status variables in response to the detector determining that the user is engaged with the device;
a comparator to determine whether the context data object has changed from a first instance of the context data object; and
a toolset including a plurality of components capable of triggering one or more actions in response to the comparator determining that the context data object has changed from the first instance of the context data object.

18. An apparatus as defined in claim 17, wherein the components of the toolset includes a prompt generator to generate a prompt to be displayed to the user of the healthcare information system, the prompt including data related to the change in the context data object.

19. An apparatus as defined in claim 17, wherein the components of the toolset includes an application router to launch a second application on the healthcare information system, the second application configured to provide services associated with a type of information associated with the changed context data object.

20. An apparatus as defined in claim 17, wherein the components of the toolset includes a document access grantor to grant the user access to a document that is newly available according to the change in the context data object.

21. An apparatus as defined in claim 17, wherein the context data object comprises a patient context data object.

22. An apparatus as defined in claim 17, wherein a first one of the status variables is indicative of an aspect of a session of the user with the device associated with the healthcare information system.

23. An apparatus as defined in claim 17, wherein the first instance of the context data object corresponds to a prior version of the context data object at a previous time.
